(19) United States
(12) Patent Application Publication
(10) Pub. No.: US 2023/0220149 A1
(43) Pub. Date: Jul. 13, 2023

(54) IMPROVED RIGID PUR AND PIR FOAM

(71) Applicant: RECTICEL, Brussel (BE)

(72) Inventors: Koen VANLANDSCHOOT, Wetteren (BE); Mehmet ISIK, Wetteren (BE); Anick SPRIET, Wetteren (BE); Marc VLAEMINCK, Wetteren (BE); Geert SNELLINGS, Wetteren (BE)

(21) Appl. No.: 17/759,137

(22) PCT Filed: Jan. 22, 2021
(86) PCT No.: PCT/EP2021/051451

§ 371 Date: Jul. 20, 2022

(30) Foreign Application Priority Data
Jan. 24, 2020 (EP) 20153738.8

(51) Int. Cl. C08G 18/78; C08G 18/76; C08G 18/42; C08G 18/48; C08G 18/32; C08G 18/66; C08G 18/22; C08G 18/18; C08G 18/16; C08J 9/14

(52) U.S. Cl. CPC C08G 18/7887; C08G 18/7671; C08G 18/7806; C08G 18/7614; C08G 18/4213; C08G 18/4829; C08G 18/3218; C08G 18/3275; C08G 18/329; C08G 18/6688; C08G 18/225; C08G 18/1808; C08G 18/1816; C08G 18/163; C08J 9/144; C08J 9/141; C08J 9/146; C08G 2110/0025; C08J 2203/162; C08J 2203/142; C08J 2201/022; C08J 2205/10; C08J 2375/06; C08J 2375/08

(57) ABSTRACT

A method for preparing rigid polyurethane (PUR) foams or rigid polyisocyanurate (PIR) foams in which method the rigid PUR or PIR foam is prepared by reacting a composition (C) comprising: at least one isocyanate-reactive component (B1) having functional groups selected from hydroxyl, amine and thiol groups; at least one isocyanate component (A1) having an average functionality of less than 2.70; and at least one blowing agent [blowing agent (BA), herein after]; with the proviso that the overall average functionality [F_{n,avg(A)}, herein after] of all isocyanate components present in the composition (C) is less than 2.70; wherein the composition (C) is characterized by an isocyanate index X, wherein the rigid PUR or PIR foams are produced by depositing the composition (C) between two gas-tight facing sheets and wherein the rigid PUR or PIR foam is characterized by a difference Δλ between the initial thermal conductivity value λᵢₙᵢ and the aged thermal conductivity value λ_{aged} of said rigid PUR or PIR foam wherein: when X≤200 then Δλ<1.35; and when X>200 then Δλ<[6.49−(4.46*F_{n,avg(A)})−(0.02348*X)+(0.492*F_{n,avg(A)}*F_{n,avg(A)})+(0.01343*F_{n,avg(A)}*X)+0.3].

### FIELD OF THE INVENTION

The present invention relates to an improved method for preparing rigid polyurethane (PUR) or polyisocyanurate (PIR) foams. The present invention further relates to PUR and PIR foams exhibiting an improved ageing behaviour and their use.

### BACKGROUND OF THE INVENTION

Rigid polyurethane (PUR) and polyisocyanurate (PIR) foams find widespread use. They are for instance used as heat insulators in building and construction, in cooling and heating technology such as for household appliances, for producing composite materials, such as sandwich elements for roofing and siding, and for wood simulation material, model-making material, and packaging insulation.

The term “rigid foams” is commonly used to refer to foams with a closed cell structure which are produced by an expansion process, known as “foaming”. The majority of rigid foams have a comparatively low weight per unit volume and a low thermal conductivity. Rigid foams based on PUR or PIR are well established and are produced, for example, by an exothermic reaction of a polyol with an isocyanate in the presence of a blowing agent. Foams made using a stoichiometrically balanced mixture of polyol and isocyanate (i.e. an isocyanate index of around 100) are known as PUR foams. If a sufficient excess of isocyanate is used, isocyanurate ring structures are formed by trimerization of the isocyanate components, leading to PIR foams which are characterised by an increased crosslinking, increased thermal and flame resistance and low smoke generation during burning.

Such rigid PUR or PIR foams, especially those used in thermal insulation applications, are commonly characterised by their lambda value which is a measure of their thermal conductivity. A lower value of lambda is beneficial as it signifies a lower thermal conductivity and consequently good thermal insulation properties. The excellent thermal insulation properties of rigid PUR or PIR foams are a result of the fine cell structure, the low density of the foam and the presence of an insulating gas, i.e. the blowing agent, within the foam cells. Owing to the high closed-cell content of rigid PUR or PIR foams (proportion of closed cells>90%), the blowing agents remain in the foam material over the long term.

Nowadays, further improvements in the thermal conductivity of rigid PUR or PIR foam materials are still being sought after, especially for insulation applications in view of increasing energy costs and the possibility of further tightening of government energy efficiency requirements. Although rigid PUR or PIR foams can exhibit excellent insulation properties when first formed, there is a tendency for their insulation properties to deteriorate over time, either on storage or when in position for use. Namely, their thermal conductivity, hence the value of lambda, tends to increase. This increment caused by ageing is often called delta lambda and is determined by comparing the initial lambda value with the aged lambda value. The thermal conductivity levels specified by manufacturers, the declared value of thermal conductivity (λ_{D}), are long-term values which allow for these possible ageing effects and thus take into account the delta lambda value. These declared lambda values are based on a rigid foam material lifetime of at least 25 years since in practice the lifetime is expected to be greater than 60 years. Annex C of the product standard EN 13165 describes the procedures for determining the effects of ageing on rigid PUR or PIR foams. The initial values of thermal conductivity (λᵢₙᵢ) are determined within the framework of third-party monitoring in accordance with NBN EN 13165 one to eight days after the manufacture of the rigid PUR or PIR foams by a test institute approved by the building authorities. The declared lambda value λ_{D} is determined from the initial measured lambda values λᵢₙᵢ, taking into account the statistical scatter, and the fixed safety increment. The fixed increment is based on the normality test, as described on former mentioned international standard.

US 2004/0162359 A1 discloses rigid PUR or PIR foams having a relatively small cell size and having improved insulation properties. In US 2004/0162359 A1 it was found that a small cell size contributes to an improved aged thermal resistance R. Therefore, the aim was to obtain rigid PUR or PIR foams with as many small, closed cells as possible. The rigid foams are made from a mixture that contains an aromatic polyester polyol, a polyisocyanate, and water as a blowing agent. The amount of polyisocyanate is such that the mixture has an isocyanate index less than 350.

EP 1219653 A1 discloses cyclopentane blown rigid PUR or PIR foams with improved flame resistance and reduced thermal conductivity based on aromatic polyester polyols and polyisocyanates. In addition, the use of aliphatic, cycloaliphatic or heterocyclic polyester polyols is also proposed. In EP 1219653 A1 initial lambda values as low as 17.2 mW/m·K measured at 10° C. according to standard ISO 8301 are reported on rigid PUR foams containing an isocyanate component having an average functionality of more than 2.7 (i.e. Suprasec® 2085 with an average functionality of 2.9). No aged lambda values or delta lambda values are reported and no mention is made of an improved ageing behaviour.

US 2016/0319096 A1 describes pentane-blown PIR foam composites. To overcome the problem of pentane's poor miscibility with polyols, man-made vitreous fibres (MMVF) were added to the reactive composition. In US 2016/0319096 A1 it was found that the inclusion of MMVF results in rigid PIR foam products which exhibit less deterioration in lambda value over time. According to US 2016/0319096 A1 the reduced deterioration in lambda value is linked to a smaller average cell size and a higher closed cell content. Delta lambda values of 4.3, 4.6 and 8.0 mW/m·K were reported and the initial and 14-days aged lambda values were measured at room temperature according to EN12667 (the values for the initial or aged lambda values were not reported). However, a significant drawback of the process of US 2016/0319096 A1 is that it requires a composition with an extra ingredient on top of the conventional composition, which in turn creates extra raw material costs. Furthermore, the reported method and the reduced delta lambda values are limited to rigid PIR foams.

Therefore, there remains a need for an improved environmentally friendly method to produce rigid PUR or PIR foams which exhibit a reduced deterioration in lambda value over time, hence which exhibit a small ageing increment Δλ, a lower declared lambda value and better insulating properties.

### SUMMARY OF THE INVENTION

The inventors have now surprisingly found that it is possible to provide an improved method fulfilling the above-mentioned needs.

Thus, the object of the present invention is to provide a method for preparing rigid polyurethane (PUR) foams [rigid PUR foam, herein after] or rigid polyisocyanurate (PIR) foams [rigid PIR foam, herein after] in which method the rigid PUR or PIR foam is prepared by reacting a composition (C) comprising:
at least one isocyanate-reactive component having functional groups selected from hydroxyl, amine and thiol groups [isocyanate-reactive component (B1), herein after];
at least one isocyanate component having an average functionality of less than 2.70 [isocyanate component (A1), herein after];
at least one blowing agent [blowing agent (BA), herein after];
   with the proviso that the overall average functionality [F_{n,avg(A)}, herein after] of all isocyanate components present in the composition (C) is less than 2.70; and wherein the composition (C) is characterized by an isocyanate index X; and wherein the rigid PUR or PIR foams are produced between gas-tight facing sheets; and
   wherein the rigid PUR or PIR foam is characterized by a difference between the initial thermal conductivity value λᵢₙᵢ and the aged thermal conductivity value λ_{aged} [λΔ, herein after] of said rigid foam wherein:

when X≤200 then Δλ<1.35; and

when X>200 then Δλ<[6.49−(4.46*_{n,avg(A)})−(0.02348*X)+(0.492*F_{n,avg(A)}*_{n,avg(A)})+(0.01343*F_{n,avg(A)}*X)+0.3],

wherein the initial thermal conductivity value λᵢₙᵢ, and the aged thermal conductivity value λ_{aged}, expressed as mW/m·K at 10° C., are measured in accordance with ASTM C518 with a Fox 304 thermal conductivity instrument with a temperature gradient from 0° C. to 20° C., the initial thermal conductivity value λᵢₙᵢ is measured within 24 hours after production of the rigid PUR or PIR foam, the aged thermal conductivity value λ_{aged} is measured after ageing at 23° C./50% RH until the thermal conductivity difference between three consecutive weekly measurements is less than 0.05 mW/m·K.

It is a further object of the present invention to provide rigid PUR or PIR foams obtained according to the method as detailed above.

It is also a further object of the present invention to provide uses of said rigid PUR or PIR foams.

### DETAILED DESCRIPTION

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to composition consisting only of components A and B. It means that with respect to the present invention, the only relevant components of the composition are A and B. Accordingly, the terms “comprising” and “including” encompass the more restrictive terms “consisting essentially of” and “consisting of”.

Within the context of the present invention, the expression “at least one isocyanate-reactive component (B1)” is intended to denote one or more than one isocyanate-reactive component (B1). Mixtures of isocyanate-reactive components (B1) can also be used for the purpose of the invention. In the remainder of the text, the expression “isocyanate-reactive component (B1)” is understood, for the purposes of the present invention, both in the plural and the singular form.

The term “rigid PUR or PIR foam” is intended to denote PUR or PIR foams that have a compressive strength, measured according to EN 826:013, of at least 50 kPa at a deformation of 10%.

As used in the foregoing and hereinafter, the following definitions apply unless otherwise noted.

### [Isocyanate Component (A1)]

Thus, in the method of the present invention use is made of at least one isocyanate component (A1) having an average functionality of less than 2.70.

Within the context of the present invention, the term “average functionality” of an isocyanate component refers to the number of —N═C═O (NCO) functional groups per molecule, on average.

Preferably, the average functionality of the at least one isocyanate component (A1) as used in the method according to the present invention is equal to or less than 2.60, more preferably equal to or less than 2.50, preferably equal to or less than 2.40, more preferably equal to or less than 2.30, even more preferably equal to or less than 2.20, yet even more preferably equal to or less than 2.10.

If desired, other isocyanate components, different from isocyanate components (A1) and not fulfilling the requirement of having an average functionality less than 2.70 [other isocyanate components (AO), herein after], may be added to the composition (C). However, it is necessary that, when more than one isocyanate component is present, then the overall average functionality of all the isocyanate components in the composition (C) should be less than 2.70. The overall average functionality can be calculated by taking into account the amount of each isocyanate component and its respective functionality. For example, a mixture of 50 g of an isocyanate component with an average functionality of 2.90 and 150 g of an isocyanate component with an average functionality of 2.10 will have an overall average functionality of 2.30 (i.e. ((2.9*(50/200)+(2.1*(150/200)).

Preferably, the overall average functionality of all the isocyanate components in the composition (C) as used in the method according to the present invention is equal to or less than 2.60, more preferably equal to or less than 2.50, preferably equal to or less than 2.40, more preferably equal to or less than 2.30, even more preferably equal to or less than 2.20, yet even more preferably equal to or less than 2.10.

The inventors have now surprisingly found that rigid PUR or PIR foams can be obtained showing an improved ageing behaviour, i.e. having a reduced value of delta lambda, when the rigid foams are prepared with at least one isocyanate component (A1) of which the average functionality is less than 2.70 and wherein the overall average functionality of all isocyanate components present in the composition (C) is less than 2.70, compared to rigid PUR or PIR foams wherein the overall average functionality of all isocyanate components present in the composition (C) is equal to or higher than 2.70.

In one embodiment of the method according to the present invention, the at least one isocyanate component (A1) is having a percentage of di-functional isocyanate components as determined by GPC of more than 35%, preferably equal to or more than 36%, more preferably equal to or more than 37%, even more preferably equal to or more than 38%, yet even more preferably equal to or more than 39%, yet even more preferably equal to or more than 40%, relative to the total amount of the isocyanate component (A1).

The method to determine the percentage of di-functional isocyanate components in the isocyanate component (A1) or in all the isocyanate components in the composition (C) is explained in detail in the experimental section.

The term “di-functional isocyanate components” is intended to denote the isocyanate components with two isocyanate (NCO) functional groups. In the case uretonimine-modified isocyanates are used, this includes also the mono-, bis- and tris-isocyanate-uretonimine components.

When more than one isocyanate component is present in the composition (C) as used in the method according to the present invention, the percentage of di-functional isocyanate components as determined by GPC of all the isocyanate components present in the composition (C) is preferably more than 35%, preferably equal to or more than 36%, more preferably equal to or more than 37%, even more preferably equal to or more than 38%, yet even more preferably equal to or more than 39%, most preferably equal to or more than 40%, relative to the total amount of all isocyanate components in the composition (C).

The inventors have surprisingly found that rigid PUR or PIR foams can be obtained showing an improved ageing behaviour, i.e. having a reduced value of delta lambda, when the percentage of di-functional isocyanate components as determined by GPC in the at least one isocyanate component (A1) or in all isocyanate components present in the composition (C) used to prepare the rigid PUR or PIR foams, is more than 35%.

In a preferred embodiment of the method according to the present invention, the at least one isocyanate component (A1) as used in the method according to the present invention is an aromatic isocyanate component (A1).

When more than one isocyanate component is present in the composition (C), preferably all isocyanate components are aromatic isocyanate components.

Typical aromatic isocyanate components (A1) having an average functionality of less than 2.70 suitable for use in the method of the present invention may include, but are not limited to, diisocyanates having aromatic structures, such as 2,2-, 2,4′- and 4,4′-diphenylmethane diisocyanate (e.g. MDI-based isocyanates and their mixtures or modified variants) and 2,4- and 2,6-toluene diisocyanate (e.g. TDI-based isocyanates and their mixtures or modified variants).

The acronym MDI is in the PU industry used for diphenyl methane diisocyanate, also called methyl diphenyl diisocyanate or methylene diphenyl diisocyanate, and this may include methyl or methylene diphenyl-4,4′-diisocyanate, also known as methane diphenyl-4,4′-diisocyanate, 1-isocyanato-4-[(4-isocyanatophenyl)methy] benzene, 4,4′-diphenylmethane diisocyanate and 4,4′-methylene diphenyl diisocyanate, together with its 2,4′ and 2,2′ isomers, or may also be used for the 4,4′-MDI monomer as a single isomer, or for a blend of two of the three isomers, such as a mixture of the 4,4′ and the 2,4′ isomer. In the context of the present invention, the terms MDI, mMDI, monomeric MDI and MDI monomer are used in its broadest sense, covering all of these possible compositions of the methane diphenyl diisocyanate monomers.

Preferred aromatic isocyanate components (A1) are MDI-based isocyanates, such as ‘pure MDI’, uretonimine-modified pure MDI or prepolymers based on MDI. The isocyanate components may be modified as would be readily understood by those skilled in the field of PUR or PIR foam chemistry.

Aromatic isocyanate components (A1) having an average functionality of less than 2.70 are known to those skilled in the art.

Non limitative examples of commercially available aromatic isocyanate components (A1) having an average functionality less than 2.70, suitable for use in the method of the present invention may include, but are not limited to, Suprasec® 2020, Suprasec® 2029, available from Huntsman. Lupranat® ME, Lupranat® MI, Lupranat® MIP, Lupranat® MM 103. Lupranat® MP 102. Lupranat® M-10-R, available from BASF. Voranate™ 2940, available from Dow®, Ongronat® 3050, available from BorsodChem.

For a number of reasons, such as a better control of the final composition (C), or of the rigid foam properties, for obtaining a composition (C) giving a faster final cure and less heat generation when the reactants are mixed together, the method according to the present invention may make use of isocyanate terminated prepolymers having an average functionality less than 2.70. Isocyanate terminated prepolymers are prepared by reacting an excess of one or more isocyanate components with a minor amount, e.g. about 10 weight percent or less, based on the weight of the isocyanate component, of one or more isocyanate-reactive components. A large molar excess of isocyanate is desired, e.g. a molar excess of about 600% or greater, preferably up to about 900%. Suitable isocyanate-reactive components for preparing the prepolymers are those containing at least two active hydrogen-containing groups that are isocyanate-reactive. Typifying such components are hydroxyl-containing polyesters, polyalkylene ether polyols, hydroxyl-terminated polyurethane oligomers, polyhydric polythioethers, ethylene oxide adducts of phosphorous-containing acids, polyacetals, aliphatic polyols, aliphatic thiols including alkane, alkene, and alkyne thiols having two or more SH groups, as well as mixtures thereof. Components that contain two or more different groups within the above-defined classes can also be used such as, for example, components that contain both an SH group and an OH group. Such isocyanate terminated prepolymers are available commercially. Popular examples are made by reacting monomeric MDI (mMDI) with a small amount of diols and/or triols.

### [Isocyanate-Reactive Component (B1)]

Thus, in the method of the present invention use is made of at least one isocyanate-reactive component (B1) having functional groups selected from hydroxyl, amine and thiol groups such as polyether polyols, polyester polyols, polyols derived from vegetable oils, polymeric polyols and polyetheramines. In principle, each molecule comprising active hydrogen groups can serve as the at least one isocyanate-reactive component (B1).

Preferably, the at least one isocyanate-reactive component (B1) is having functional groups comprising hydroxyl such as, but not limited to, polyether polyols, polyester polyols and mixtures thereof, as known for the production of rigid PUR or PIR foams, which have an equivalent weight of from 40 to 2000, preferably from 100 to 1000 and an average functionality of from 2 to 8, preferably from 2 to 6. The production of these polyether and polyester polyols and the way to control their equivalent weights and average functionalities is well known in the art.

In the context of this invention, the prefix “poly” is used for meaning “more than one”, which when limited to integers is the same as “2 or more” or “at least 2”. The term “polyol” therefore stands for a component having at least 2 hydroxyl (—OH) functional groups.

The term “average functionality” of an isocyanate-reactive component indicates the number of hydroxyl, amine and/or thiol groups per molecule, on average.

In one embodiment of the method according to the present invention, the at least one isocyanate-reactive component (B1) is selected from polyether polyols prepared by polyaddition of propylene oxide and/or ethylene oxide on low molecular weight initiators with OH-, NH- and/or NH₂-groups having an equivalent weight from 40 to 2000, preferably from 100 to 1000 and having an average functionality of 2 to 8, preferably 2 to 6. This functionality corresponds to the average functionality of the polyether polyol.

Typical polyether polyols suitable for use in the method of the present invention may include, but are not limited to, reaction products of ethylene oxide or propylene oxide and an initiator compound containing 2 to 8 active hydrogen atoms, such as water, ethylene glycol, glycerol, pentaerythritol, sorbitol, sucrose and mixtures thereof.

Non limitative examples of commercially available polyether polyols are for instance Daltolac® R585, Daltolac® R491, and Daltolac® R501, all available from Huntsman.

In a preferred embodiment of the method according to the present invention, the isocyanate-reactive component (B1) is selected from polyester polyols prepared as ester condensation products of dicarboxylic acids with low molecular weight polyols, having an equivalent weight from 50 to 2000, preferably from 100 to 600 and having an average functionality of 2 to 4, preferably of 2 to 3. This functionality corresponds to the average functionality of the polyester polyol.

Typical polyester polyols suitable for use in the method of the present invention may include, but are not limited to, condensation reaction products of phthalic anhydride and diethylene glycol and mixtures thereof.

Non limitative examples of commercially available polyester polyols are the Isoexter® type products available from the company COIM, the Polios® type products available from the company Purinova, the Stepanpol® type products available from Stepan Company. and the Hoopol® type products available from the company Synthesia.

The equivalent weight of a polyether or polyester polyol compound or mixture is defined as the average weight of the compound or mixture per reactive hydroxyl (OH) site or, for a single polyether or polyester polyol compound, as the molecular weight of the polyether or polyester polyol compound divided by its functionality. The equivalent weight of a polyol containing sample may readily be calculated from the analysed hydroxyl (OH) number, as follows:

equivalent weight polyol=56100/OH number

where OH number is the analysed hydroxyl (OH) content according to method ASTM 4274 or ISO 14900 and expressed in mg KOH/g of sample.

In another embodiment of the method according to the present invention, the isocyanate-reactive component (B1) is selected from polyols derived from vegetable oils such as castor oil, soy bean oil, peanut oil and canola oil, and other bio-based polyols.

In another embodiment of the method according to the present invention, the isocyanate-reactive component (B1) is selected from amine terminated polyethers or polyetheramines.

Non limitative examples of commercially available polyetheramines are Jeffamines® as commercially available from Huntsman.

In another embodiment of the method according to the present invention, the isocyanate-reactive component (B1) is selected from polymeric polyols such as polyols derived from chemolytic recycling of polyurethane.

### [Blowing Agent (BA)]

It is understood that the amount of blowing agent (BA) in the composition (C) is dependent upon the foam density to be obtained and upon the molecular weight of the blowing agent.

In a preferred embodiment of the method of the present invention, the amount of blowing agent (BA) in the composition (C) is advantageously equal to or greater than 5 parts by weight, preferably equal to or greater than 10 parts by weight, more preferably equal to or greater than 15 parts by weight, relative to 100 parts by weight of the composition (C).

It is further understood that, the amount of blowing agent (BA) in the composition (C) is advantageously equal to or less than 60 parts by weight, preferably equal to or less than 55 parts by weight, more preferably equal to or less than 50 parts by weight, most preferably equal to or less than 45 parts by weight, relative to 100 parts by weight of the composition (C).

It is further understood that, the amount of blowing agent (BA) in the composition (C) ranges from 5 to 60 parts per weight, or from 10 to 55 parts per weight, or from 15 to 50 parts per weight, or from 15 to 45 parts per weight.

In a preferred embodiment of the method of the present invention, the total amount of blowing agents in the composition (C) is advantageously equal to or greater than 5 parts by weight, preferably equal to or greater than 10 parts by weight, more preferably equal to or greater than 15 parts by weight, relative to 100 parts by weight of the composition (C).

It is further understood that, the total amount of blowing agents in the composition (C) is advantageously equal to or less than 60 parts by weight, preferably equal to or less than 55 parts by weight, more preferably equal to or less than 50 parts by weight, most preferably equal to or less than 45 parts by weight, relative to 100 parts by weight of the composition (C).

It is further understood that, the total amount of blowing agents in the composition (C) ranges from 5 to 60 parts per weight, or from 10 to 55 parts per weight, or from 15 to 50 parts per weight, or from 15 to 45 parts per weight.

In a preferred embodiment of the method according to the present invention use is made of at least one blowing agent (BA) having a thermal conductivity value λ of equal to or less than 13.00 mW/m·K, measured at 10° C. in accordance with the transient hot wire method (THW method).

The thermal conductivity value of the blowing agent (BA) is measured at 10° C. in accordance with the transient hot wire method (THW method), as detailed in the experimental section, as reported in the Journal or Research of the National Bureau of Standards. Vol. 86, No. 5. September-October 1981, p. 457-493, by H. M. Roder, herein incorporated by reference, and as referenced to in the Journal of Chemical and Engineering Data, Vol. 62, No. 9, p. 2659-2665, herein incorporated by reference.

Preferably, the thermal conductivity value λ measured at 10° C. in accordance with the THW method of the blowing agent (BA) as used in the method according to the present invention is equal to or less than 12.50 mW/m·K, preferably less than 12.00 mW/m·K, more preferably less than 11.50 mW/m·K, even more preferably less than 11.00 mW/m·K, yet even more preferably less than 10.50 mW/m·K, most preferably less than 10.00 mW/m·K.

If desired, other blowing agents, different from blowing agents (BA) and not fulfilling the requirement of having a thermal conductivity value λ of equal to or less than 13.00 mW/m·K measured at 10° C. in accordance with the THW method [other blowing agents (BAO), herein after], may be added to the composition (C). However, it is necessary that when more than one blowing agent is used than the overall conductivity value λ of all blowing agents in the composition (C) should be equal to or less than 13.00 mW/m·K. The overall thermal conductivity value λ can be calculated by taking into account the molar ratio of all used blowing agents.

Preferably, the overall thermal conductivity value λ of all the blowing agents in the composition (C) as used in the method according to the present invention is equal to or less than 13.00 mW/m·K, more preferably equal to or less than 12.50 mW/m·K, more preferably less than 12.00 mW/m·K, more preferably less than 11.50 mW/m·K, even more preferably less than 11.00 mW/m·K, yet even more preferably less than 10.50 mW/m·K, most preferably less than 10.00 mW/m·K.

Preferably, blowing agents (BA) suitable for use in the method of the present invention are selected from the group comprising methyl formate, 1,1,1,2-tetrafluoroethane, dimethoxymethane, pentafluoroethane, 1,1,1,3,3-pentafluoropropane (HFC245fa), 1,1,1,3,3-pentafluorobutane (Solkane® 365), difluoromethane, any hydrofluoroolefins (HFO) such as 2,3,3,3-tetrafluoropropene, 3,3,3-trifluoropropene, 1,1,1,4,4,4-hexafluoro-2-butene, 2-bromopentafluoropropene, 1-bromopentafluoropropene, or any HCFO such as 1-chloro-3,3,3-trifluoropropene or 1,1-dichloro-3,3,3-trifluoropropene or 2-chloro-3,3,3-trifluoropropene, cyclopentane, i-pentane, n-pentane or mixtures of two or more thereof.

More preferably, the blowing agent is a blowing agent having a negligible ozone depletion and low global warming potential, such as, but not limited to: trans-1-chloro-3,3,3-trifluoropropene (commercially available from Honeywell as Solstice® LBA or HFO 1336), trans-1,3,3,3-tetrafluoropropene (commercially available from Honeywell as Solstice® GBA or HFO 1234ze(E)) or 1,1,1,4,4,4-hexafluoro-2-butene (commercially available as Opteon™ 1100 from Chemours).

Preferably, water is not used in the method according to the present invention or, if used, only in amounts of less than 2.0 parts by weight relative to 100 parts by weight of the composition (C).

[Composition (C) and Rigid Foam]

It is further understood that all definitions and preferences, as described above, equally apply for all further embodiments, as described below.

Thus, in the method according to the present invention, a rigid PUR or PIR foam is prepared by reacting a composition (C) comprising at least one isocyanate-reactive component (B1), as detailed above, at least one isocyanate component (A1), as detailed above, and at least one blowing agent (BA), as detailed above, wherein the composition (C) is characterized by an isocyanate index X and wherein the rigid PUR or PIR foam is produced between gas-tight facing sheets; and is characterized by a delta lambda value Δλ wherein:

when X≤200 then Δλ<1.35; and

when X>200then Δλ<[6.49−(4.46*F_{n,avg(A)})−(0.02348*X)+(0.492*F_{n,avg(A)}*F_{n,avg(A)})+(0.01343*F_{n,avg(A)}*X)+0.3],

wherein the initial thermal conductivity value λᵢₙᵢ and the aged thermal conductivity value λ_{aged}, expressed as mW/m·K at 10° C., are measured in accordance with ASTM C518 with a Fox 304 thermal conductivity instrument with a temperature gradient from 0° C. to 20° C., the initial thermal conductivity value λ_{aged} is measured within 24 hours after production of the rigid PUR or PIR foam, the aged thermal conductivity value λ_{aged} is measured after ageing at 23° C./50% RH until the thermal conductivity difference between three consecutive weekly measurements is less than 0.05 mW/m·K.

The terms “initial lambda value” or “initial thermal conductivity” are intended to denote the thermal conductivity, expressed as mW/m·K at 10° C., which is measured on the rigid PUR or PIR foam within 24 hours after its production in accordance with ASTM C518 with a Fox 304 thermal conductivity instrument with a temperature gradient from 0° C. to 20° C.

The terms “aged lambda value” or “aged thermal conductivity” are intended to denote the lambda value, expressed as mW/m·K at 10° C., obtained after an ageing period of the rigid PUR or PIR until the lambda value of three consecutive weekly measurements is less than 0.05 mW/m·K. The aged lambda value λ_{aged} is measured in accordance with ASTM C518 with a Fox 304 thermal conductivity instrument with a temperature gradient from 0° C. to 20° C.

The initial and aged thermal conductivity values of the rigid PUR or PIR foams as produced according to the method of the present invention are measured at 10° C. in accordance with ASTM C518, as detailed in the experimental section below.

In the context of the present invention, the isocyanate index X for a composition (C) is defined as:

$$Isocyanate index X = \frac{Actual amount of isocyanate used}{Theoretical amount of isocyanate required} \times 100$$

The isocyanate index X is the ratio of the amount of isocyanate used relative to the theoretical equivalent amount required, which is often being expressed as a percentage and possibly even without mentioning the percentage indicator. The isocyanate index X is calculated relative to the total number of isocyanate-reactive functional groups present, and this prior to the occurrence of any condensation reaction. The isocyanate index X for a composition is thus also a measure of the excess of isocyanate functional groups relative to the theoretical equivalent amount required.

The isocyanate index X depends on the amount of the isocyanate component (A1) and the amount of the isocyanate-reactive component (B1).

When more than one isocyanate component and/or more than one isocyanate-reactive component is present in the composition (C), the isocyanate index X depends on the relative amounts and the NCO content, expressed as % NCO, of all isocyanate components and the relative amounts of all isocyanate-reactive components.

In the present invention, the isocyanate index X of the composition (C) is advantageously higher than 90 and equal to or lower than 400.

Another aspect of the present invention is to provide a method for preparing rigid polyurethane (PUR) foams [rigid PUR foam, herein after] or rigid polyisocyanurate (PIR) foams [rigid PIR foam, herein after] in which method the rigid PUR or PIR foam is prepared by reacting a composition (C) comprising:
at least one isocyanate-reactive component having functional groups selected from hydroxyl, amine and thiol groups [isocyanate-reactive component (B1), herein after], as detailed above;
at least one isocyanate component having an average functionality of less than 2.70 [isocyanate component (A1), herein after], as detailed above:
at least one blowing agent having a thermal conductivity value λ of equal to or less than 13.00 mW/m·K measured at 10° C. in accordance with a transient hot wire method (THW method) [blowing agent (BA), herein after], as detailed above;
   with the proviso that the overall average functionality [F_{n,avg(A)}, herein after] of all isocyanate components present in the composition (C) is less than 2.70 and the overall thermal conductivity value λ of all blowing agents present in the composition (C) is equal to or less than 13.00 mW/m·K; and wherein the composition (C) is characterized by an isocyanate index X, wherein 90<X≤400; and wherein the rigid PUR or PIR foams are produced between gas-tight facing sheets.

It is understood that for the rigid PUR foams of the present invention, the isocyanate index X of the composition (C) is typically higher than 90, preferably higher than 95, more preferably higher than 100 and most preferably higher than 105, the isocyanate index X being preferably lower than 180, being preferably lower than 150, more preferably lower than 130, even more preferably lower than 120.

Advantageously, the isocyanate index X of the composition (C) in the rigid PUR foams ranges from 90 to 200, preferably from 90 to 180, more preferably from 90 to 150.

It is further understood that in the rigid PIR foams of this invention, the isocyanate index X of the composition (C) is advantageously equal to or higher than 180, preferably equal to or higher than 200, more preferably equal to or higher than 220, even more preferably equal to or higher than 240 and most preferably equal to or higher than 270, the isocyanate index X being preferably equal to or lower than 400, preferably equal to or lower than 350, more preferably equal to or lower than 340, more preferably equal to or lower than 335.

Advantageously, the isocyanate index X of the composition (C) in the rigid PIR foams ranges from 200 to 400, preferably from 270 to 400, more preferably from 270 to 335.

According to one embodiment of the present invention, the composition (C) is characterized by an isocyanate index X≤200 and the composition (C) comprises the at least one isocyanate component (A1) in an amount equal to or more than 20 parts by weight, preferably equal to or more than 30 parts, more preferably equal to or more than 40 parts by weight, relative to 100 parts by weight of the total amount of isocyanate components present in the composition (C).

In this embodiment, when X≤200 then advantageously Δλ<1.25, more preferably Δλ<1.15, more preferably Δλ<1.10, even more preferably Δλ<1.05, most preferably Δλ<1.00.

According to a preferred embodiment of the present invention, the composition (C) is characterized by an isocyanate index X, wherein 90<X≤200 and the composition (C) comprises the at least one isocyanate component (A1) in an amount equal to or more than 20 parts by weight, preferably equal to or more than 30 parts, more preferably equal to or more than 40 parts by weight, relative to 100 parts by weight of the total amount of isocyanate components present in the composition (C).

In this embodiment, when 90<X≤200 then advantageously Δλ<1.25, more preferably Δλ<1.15, more preferably Δλ<1.10, even more preferably Δλ<1.05, most preferably Δλ<1.00.

According to a more preferred embodiment of the present invention, the composition (C) is characterized by an isocyanate index X, wherein 90<X≤180 and the composition (C) comprises the at least one isocyanate component (A1) in an amount equal to or more than 20 parts by weight, preferably equal to or more than 30 parts, more preferably equal to or more than 40 parts by weight, relative to 100 parts by weight of the total amount of isocyanate components present in the composition (C).

In this embodiment, when 90<X≤180 then advantageously Δλ<1.25, more preferably Δλ<1.15, more preferably Δλ<1.10, even more preferably Δλ<1.05, most preferably Δλ<1.00.

According to a more preferred embodiment of the present invention, the composition (C) is characterized by an isocyanate index X, wherein 90<X≤150 and the composition (C) comprises the at least one isocyanate component (A1) in an amount equal to or more than 20 parts by weight, preferably equal to or more than 30 parts, more preferably equal to or more than 40 parts by weight, relative to 100 parts by weight of the total amount of isocyanate components present in the composition (C).

In this embodiment, when 90<X≤150 then advantageously Δλ<1.25, more preferably Δλ<1.15, more preferably Δλ<1.10, even more preferably Δλ<1.05, most preferably Δλ<1.00.

According to another embodiment of the present invention, the composition (C) is characterized by an isocyanate index X, wherein X>200 and the composition (C) comprises the at least one isocyanate component (A1) in an amount equal to or more than 5 parts by weight, preferably equal to or more than 10 parts, more preferably equal to or more than 20 parts by weight, relative to 100 parts by weight of the total amount of isocyanate components present in the composition (C).

In this embodiment, when X>200 then Δλ<[6.49−(4.46*F_{n,avg(A)})−(0.02348*X)+(0.492*F_{n,avg(A)},*F_{n,avg(A)})+(0.01343*F_{n,avg(A)}*X)+0.3].

According to a preferred embodiment of the present invention, the composition (C) is characterized by an isocyanate index X, wherein 200<X≤400 and the composition (C) comprises the at least one isocyanate component (A1) in an amount equal to or more than 10 parts by weight, preferably equal to or more than 15 parts, more preferably equal to or more than 20 parts by weight, relative to 100 parts by weight of the total amount of isocyanate components present in the composition (C).

In this embodiment, when 200<X≤400 then Δλ<[6.49−(4.46*F_{n,avg(A)})−(0.02348*X)+(0.492*F_{n,avg(A)}*F_{n,avg(A)})+(0.01343*F_{n,avg(A)}*X)+0.3].

According to a preferred embodiment of the present invention, the composition (C) is characterized by an isocyanate index X, wherein 270≤X≤400 and the composition (C) comprises the at least one isocyanate component (A1) in an amount equal to or more than 10 parts by weight, preferably equal to or more than 15 parts, more preferably equal to or more than 20 parts by weight, relative to 100 parts by weight of the total amount of isocyanate components present in the composition (C).

In this embodiment, when 270≤X≤400 then Δλ<[6.49−(4.46*F_{n,avg(A)})−(0.02348*X)+(0.492*F_{n,avg(A)})*F_{n,avg(A)})+(0.01343*F_{n,avg(A)}*X)+0.3].

According to a more preferred embodiment of the present invention, the composition (C) is characterized by an isocyanate index X, wherein 270≤X≤335 and the composition (C) comprises the at least one isocyanate component (A1) in an amount equal to or more than 10 parts by weight, preferably equal to or more than 15 parts, more preferably equal to or more than 20 parts by weight, relative to 100 parts by weight of the total amount of isocyanate components present in the composition (C).

In this embodiment, when 270≤X≤335 then Δλ<[6.49−(4.46*F_{n,avg(A)})−(0.02348*X)+(0.492*F_{n,avg(A)}*F_{n,avg(A)})+(0.01343*F_{n,avg(A)}*X)+0.3].

As said, the declared lambda value λ_{D} is determined from the initial measured lambda values λᵢₙᵢ, taking into account the statistical scatter, and the fixed safety increment.

According to certain embodiments of the method according to the present invention, the composition (C) further comprises at least one catalyst to enhance the speed of the foam-making reaction between the at least one isocyanate component (A1) and the at least one isocyanate-reactive component (B1).

Typical catalysts suitable for use in the method of the present invention may include, but are not limited to, triethylene diamine, N,N-dimethylcyclohexylamine, tetramethylene diamine, 1-methyl-4-dimethylaminoethyl piperazine, triethylamine, tributylamine, dimethyl benzylamine, N,N′,N″-tris-(dimethyl-aminopropyl) hexahydrotriazine, dimethylaminopropyl formamide, N,N,N′,N′-tetramethylethylene diamine, N,N,N′,N′-tetramethyl butane diamine, tetramethyl hexane diamine, pentamethyl diethylene triamine, tetramethyl diaminoethyl ether, dimethyl piperazine, 1,2-dimethyl imidazole, 1-azabicyclo[3.3.0]octane, bis-(dimethyl aminopropyl) urea. N-methyl morpholine, N-ethyl morpholine, N-cyclohexyl morpholine, 2,3-dimethyl-3,4,5,6-tetrahydropyrimidine, triethanolamine, diethanolamine, triisopropanolamine, N-methyl diethanolamine, N-ethyl diethanolamine, dimethyl ethanolamine, tin (II) acetate, tin (II) octoate, tin (II) ethyl hexoate, tin (II) laurate, dibutyl tin diacetate, dibutyl tin dilaurate, dibutyl tin maleate, dioctyl tin diacetate, tris-(N,N-dimethyl aminopropyl)-s-hexahydrotriazine, tetramethyl ammonium hydroxide, sodium acetate, sodium octoate, potassium acetate, potassium octoate, sodium hydroxide or mixtures of two or more thereof.

Catalysts conventionally used in PUR or PIR chemistry are generally added to the at least one isocyanate-reactive component (B1). Typically, the amount of the amine-type catalysts needed to produce a PUR or PIR rigid foam and the salts used as trimerization catalysts, when present, is from 0.1 to 10 parts by weight, more preferably from 0.2 to 8 parts by weight, most preferably from 0.3 to 6 parts by weight, relative to 100 parts by weight of the composition (C).

According to certain embodiments of the method according to the present invention, the composition (C) may comprise other common additional ingredients [ingredient (1), herein after] to enhance the appearance, storage, transport, handling and/or performance of the rigid PUR or PIR foam product. Said ingredients (1) are known to those skilled in the art of rigid PUR or PIR foams. Typical ingredients (1) may include, but are not limited to, any combination of the following: heat and ultraviolet light stabilizers, catalysts, pH stabilizers, antioxidants, dulling agents, nucleating agents, surfactants, carbon derived additives (such as carbon black, graphite), thixotropic agents (e. g. amorphous silica), and fillers such as clay particles, processing aids, viscosity reducers, such as 1-methyl-2-pyrrolidinone, propylene carbonate, non-reactive and reactive flame retardants, dispersing agents, plasticizers, mould release agents, compatibility agents, and additives from natural resources such as lignin.

Typically, the amount of the ingredient (1), when present, is from 0.05 to 20 parts by weight, more preferably from 0.1 to 10 parts by weight, most preferably from 0.1 to 5 parts by weight, relative to 100 parts by weight of the composition (C).

The composition (C) as used in the method according to the present invention can be prepared by mixing together the at least one isocyanate component (A1) and optionally other isocyanate components (AO), with the at least one isocyanate-reactive component (B1), the at least one blowing agent (BA) and optionally other blowing agents (BAO), optionally a catalyst and ingredients (1) at temperatures ranging from about 0° C. to about 150° C. Any order of mixing is acceptable provided the reaction of the at least one isocyanate component (A1) and optionally other isocyanate components (AO), with the at least one isocyanate-reactive component (B1) does not begin until substantially all of the at least one isocyanate component (A1) and optionally other isocyanate components (AO), and substantially all of the at least one isocyanate-reactive component (B1) are mixed. Preferably, the isocyanate component (A1) and optionally other isocyanate components (AO), and the at least one isocyanate-reactive component (B1) do not react until all ingredients have been combined. In a preferred embodiment of the method according to the present invention, the at least one isocyanate component (A1) and optionally other isocyanate components (AO), and the at least one isocyanate-reactive component (B1) components are mixed for a short time together with the at least one blowing agent (BA) and optionally other blowing agents (BAO) in a static or dynamic mixer, prior to the addition of an optional catalyst at the point of the mixing equipment where all components come together, known as the “mixing head”. Alternatively, all components can be fed directly to the mixing head.

The method according to the present invention to produce rigid PUR or PIR foams may be a discontinuous or continuous method, with the foaming reaction of the composition (C) and subsequent curing being carried out, for example, in moulds or on conveyors. Preferably, the method according to the present invention to produce rigid PUR or PIR foams is a continuous method.

As said, the rigid PUR or PIR foams are produced between gas-tight facing sheets.

Examples of suitable gas-tight facing sheets that can be used include, but are not limited to, metal foils such as aluminum foil, lacquered aluminum foil, aluminum foil bonded with plastic film, aluminum foil bonded with paper, or a multilayer with aluminum film or metal multilayers comprising aluminum foil and those selected from gas barrier polymeric resin layers such as Ethylene Vinyl Alcohol (EVOH) copolymer resin layers or multilayers comprising said resin layers and combinations thereof.

It is known that gas-tight facing sheets being impermeable for CO₂ and air may help to improve the ageing behavior of PUR or PIR rigid foams. On one hand, gas-tight facing sheets prevent CO₂ and blowing agents from leaving the rigid PUR or PIR foam while on the other hand they prevent air from diffusing into the rigid PUR or PIR foam.

In general, the moulds used in the method of the present invention are lined up with a gas-tight facer.

Usually when the method according to the present invention is carried out by using a conveyor, the composition (C) is deposited onto a gas-tight facing sheet and another gas-tight facing sheet(s) is placed on the deposited composition (C). The deposited composition (C) is conveniently thermally cured at a temperature from about 20° C. to 150° C. in a suitable apparatus, such as an oven or heated mould. Both free rise and restrained rise processes may be employed.

However, the inventors have now found that by carrying out the production of rigid PUR or PIR foams, as detailed above, under gas-tight conditions, the improved effect on the ageing behaviour is increased, i.e. the rigid foams have a stronger reduced value of delta lambda, when the rigid foams are prepared with at least one isocyanate component (A1) of which the average functionality is less than 2.70 and wherein the overall average functionality of all isocyanate components present in the composition (C) is less than 2.70, compared to rigid PUR or PIR foams wherein the overall average functionality of all isocyanate components present in the composition (C) is equal to or higher than 2.70, as illustrated in detail in the experimental section. It has been shown by the working examples in the present invention that in the absence of gas-tight facing sheets in the production of rigid PUR or PIR foams, there is no influence of the average functionality of the isocyanate components (A1) on the ageing behaviour, in essence the value of delta lambda, of the rigid PUR and PIR foams.

It is understood that in pour-in-place or spray-foam applications of the method according to the present invention, the composition (C) is applied by pouring or spraying prior to completion of the reaction between the at least one isocyanate component (A1) with the at least one isocyanate-reactive component (B1) to produce the rigid PUR or PIR foams. For example, a delivery device containing all the components of the composition (C) can be used to apply the composition (C) at a desired location. Such application is suitable for, for example, pour-in-place formation of insulation during assembly of goods such as refrigerators. It can also be used in discontinuous panel lamination for freezer and warehouse insulation or for spray-application onto a supporting substrate. Suitable substrates include structural elements such as, for example, roofs, tanks, pipes, ducts for heat and/or ventilation, walls, modular walls and can be made, for example, of metal, concrete, brick, wood, plasterboard and the like.

Another aspect of the present invention is the rigid PUR or PIR foam obtained by the method according to the present invention, as detailed above.

It is further understood that all definitions and preferences, as described above, equally apply for all further embodiments, as described below.

Rigid PUR or PIR foams, such as those obtained by the method according to the present invention, are characterized by a “high closed cell content” and have a relatively large fraction of non-interconnecting cells, in contrast to cells having a large fraction of interconnected cells, which are commonly known as “open-celled foams”. A rigid PUR or PIR foam having a high closed cell content can nonetheless have some interconnected cells. Preferably, the rigid PUR or PIR foam obtained from the method according to the present invention, as detailed above, has 50% or more, more preferably at least about 60%, even more preferably at least about 70%, still more preferably at least about 80% and most preferably at least about 90% closed cells.

A further aspect of the present invention is the use of the rigid PUR or PIR foams obtained by the method according to the present invention, as detailed above.

The rigid PUR or PIR foams obtained by the method according to the present invention, as detailed above, can be used in a variety of applications: in the building and construction industry, as a component of laminated insulation panels for commercial built-up roofing applications; laminated insulation panels for siding applications; fabricated (cut from bunstock) insulation panels and configurations for roofing, piping, and various other insulation applications; core material for sandwich panels and as a component of simulated wood products for interior decor and furniture.

### Examples

The invention will be now described in more details with reference to the following examples, whose purpose is merely illustrative and not intended to limit the scope of the invention.

All contents in these examples are given in grams, unless stated otherwise.

The following raw materials have been used in the Examples 1-2, 4-10, 14-16, 21-22, 23-28, 31-40, 41, 44-45 and Comparative Examples 3, 11-13, 17-19, 20, 29-30, 42-43 and 46-47.

TABLE 1
Isocyanate component raw materials used in the Examples

| | | | Viscosity | | |
|---|---|---|---|---|---|
| Isocyanate | % | | (in mPa.s at | | |
| component | NCO | Functionality | 25° C.) | Description | Company |
| Lupranat ® MI | 33.5 | 2.00 | 12 | 4,4′-MDI and 2,4′-MDI | BASF |
| Lupranat ® MIP | 33.5 | 2.00 | 12 | 4,4′-MDI and 2,4′-MDI | BASF |
| Lupranat ® MM 103 | 29.5 | 2.00 | 39 | carbodiimide modified | BASF |
| | | | | 4,4′-MDI | |
| Lupranat ® MP 102 | 23 | 2.05 | 650 | polyetherpolyol based | BASF |
| | | | | 4,4′-MDI | |
| Lupranat ® M 20 S | 31.5 | 2.70 | 210 | 4,4′-MDI and oligomers | BASF |
| Lupranat ® M 10 R | 31.5 | 2.60 | 110 | 4,4′-MDI and oligomers | BASF |
| Lupranat ® T80 | 48.2 | 2.00 | / | Toluene-diisocyanate | BASF |
| | | | | (TDI) | |
| Lupranat ® T65 | 48.2 | 2.00 | / | TDI | BASF |
| Ongronat ® 3050 | 33.5 | 2.00 | Solid | Pure 4,4-MDI | BorsodChem |
| | | | (38.5° C.) | | |
| Suprasec ® 2085 | 30.5 | 2.90 | 625 | Polymeric MDI (pMDI) | Huntsman |
| | | | | | Corporation |
| Suprasec ® 2029 | 24.5 | 2.10 | 500 | Uretonimine-modified | Huntsman |
| | | | | 4,4′-MDI | Corporation |
| Suprasec ® 2020 | 29.5 | 2.10 | 40 | Uretonimine-modified | Huntsman |
| | | | | 4,4′-MDI | Corporation |
| Suprasec ® 5005 | 30.8 | 2.70 | 210 | pMDI | Huntsman |
| | | | | | Corporation |
| Voranate ™ M2940 | 32.1 | 2.30 | 40 | pMDI | The Dow |
| | | | | | Chemical |
| | | | | | Company |

### Isocyanate-Reactive Component (B1):

PUR formulations: Polyether polyol 1, OH-number: 595, viscosity (at 25° C.): 2600 mPa·s
PIR formulations:
   Polyester polyol 1: phthalic anhydride based polyester polyol. OH-number: 315, functionality: 2, viscosity (at 25 00): 2800 mPa·s
   Polyester polyol 2: phthalic anhydride based polyester polyol, OH-number: 240, functionality: 2, viscosity (at 25° C.): 3500 mPa·s
   Polyester polyol 3: aromatic polyester polyol, OH-number: 195, functionality: 2, viscosity (at 25° C.): 4350 mPa·s

### Blowing Agents (BA):

Solstice® LBA: HFO-1233zd E, trans-1-chloro-3,3,3 trifluoropropene, boiling point 19° C., thermal conductivity 9.00 mW/m·K at 10° C. (commercially available from Honeywell)
n-pentane: normal pentane, boiling point 36° C., thermal conductivity: 14 mW/m·K at 10° C.
i-pentane: iso-pentane, boiling point 27° C., thermal conductivity 13 mW/m·K at 10° C.
water

### Catalysts:

Potassium octoate, trimerization catalyst
Polycat®-5: pentamethyldiethylenetriamine (commercially available from Evonik)

### Other Ingredients:

Fire retardant: tris(chloropropyl)phosphate (TCPP)
Surfactant: polysiloxane-polyether-copolymer (Tegostab® B8513, available from Evonik)

The catalysts and the surfactant were each added in an amount of 2 to 3 parts based on 100 parts of isocyanate-reactive component (B1), both in the PIR as in the PUR formulations. The amount was varied in function of the used type of isocyanate component to adjust for the reactivity.

The fire retardant was added in such an amount that a B2 classification (DIN 4102-1 1998) was achieved.

Water was optionally added in such an amount to obtain the desired density, up to a maximum amount of 2 grams on the total amount of the composition (C).

The total amount of the polyol blend comprising the isocyanate-reactive component (B1), as indicated in the tables below, always comprises 100 grams of isocyanate-reactive component (B1) for the PIR formulations, and 90 grams of isocyanate-reactive component (B1) for all PUR formulations.

The person skilled in the art will find it easy to determine, once the raw materials are selected, which range of amounts may be used in order to achieve the desired balance of composition and properties.

General Procedure for Preparing Rigid PUR or PIR Foams Using a Mould, Lined Up with Gas-Tight Facing Sheets.

Lab procedure: The isocyanate-reactive components (i.e. the polyol), the other ingredients (i.e. catalyst, surfactant, fire retardants) and the blowing agents were mixed in a plastic cup until a homogeneous mixture was obtained. The isocyanate component was poured into the cup to obtain the reactive mixture which was immediately stirred by a stirrer at 3000 rpm for 10 seconds. The obtained mixture was transferred into a mould (5 cm thickness), lined up with a gas-tight facer (5 layer complex PE/Kraft 85-110/glue/Alu/PE20). After 10 minutes the rigid PUR or PIR foam was removed, cut to the required dimensions (30 cm*30 cm) and the initial thermal conductivity was measured. The amounts of the isocyanate-reactive component and the isocyanate component were adapted to achieve the desired isocyanate index X and are detailed in the tables below.

Pilot procedure: For each of the Examples which were produced according to the pilot procedure, the isocyanate-reactive component, catalysts, blowing agents, other ingredients and the isocyanate component were combined and reacted in the amounts indicated in the tables below. Pilot foams were prepared using a high-pressure foaming machine. The liquid output was maintained at a constant temperature of 20° C. at 20 kilograms/minute with a mixing head pressure of 150 bar. The mixture was transferred into a similar mould lined up with a gas-tight facer (5 layer complex PE/Kraft 85-110/glue/Alu/PE20), as for the handmix lab trials and all measurements were conducted in the same way.

### Test Methods

### Thermal Conductivity of Blowing Agents:

The measurements of thermal conductivity of the blowing agents were made according to the transient hot wire method (THW method), as explained above. Small platinum hot wires with a diameter of 12.7 μm serve as both electrical heaters (line source) and as resistance thermometers to measure the temperature rise of the surrounding fluid next to the wires. The measurements were performed at 10° C. (283.15 K) in a low-temperature system. It is a double-wire instrument that does not require correction for axial conduction (end effect) errors. The temperature of the low temperature cell is maintained inside a high-vacuum cryostat that is cooled with liquid nitrogen. The hot-wire cell is made from copper and is contained in a copper pressure vessel located inside an isothermal heat shield. The hot-wire cell has two parallel cylindrical cavities with a diameter of 9 mm that each have a hot wire with different lengths suspended along their central axis. The long and short hot wires are operated in a differential arrangement to eliminate errors due to axial conduction. This measurement cell requires about 25 mL of sample. A capsule standard platinum resistance thermometer (SPRT) determines the initial cell temperatures, Tᵢ, with an expanded uncertainty of U(Tᵢ)=0.005 K. A quartz pressure transducer with a range from 0 to 70 MPa determines the fluid pressure, Pₑ, with an expanded uncertainty of U(Pₑ)=7 kPa. The thermal conductivity A of the blowing agent at the working temperature and pressure is determined from the slope of the temperature rise versus the natural logarithm of the time In t. The ideal temperature rise, ΔT_{id}, is given by

$$Δ {T}_{id} = \frac{q}{4 πλ} [ ln ( t ) + ln ( \frac{4 α}{{r}_{0}^{2} C} ) ]$$

where q is the power applied per unit length, λ is the thermal conductivity of the blowing agent, t is the elapsed time, α=λ/(ρCₚ) is the thermal diffusivity of the blowing agent, ρ is the density of the blowing agent, Cₚ is the isobaric specific heat capacity of the blowing agent, r₀ is the radius of the hot wire, and C=1.781 . . . is the exponential of Euler's constant.

### Thermal Conductivity or Rigid PUR or PIR Foam:

The thermal conductivity of rigid PUR or PIR foams is measured in accordance with ASTM C518 with a Fox 304 (heat flow meter) thermal conductivity instrument. The thermal conductivity is measured with a temperature gradient from 0° C. to 20° C. The given thermal conductivity is expressed as mW/m·K at a mean temperature of 10° C.
The initial thermal conductivity is measured on the rigid PUR or PIR foam within 24 hours after its production and yields the initial lambda value λᵢₙᵢ.
The aged thermal conductivity value λ_{aged} is measured after ageing at 23° C./50% RH until the thermal conductivity difference between three consecutive weekly measurements is less than 0.05 mW/m·K.
The delta lambda value is obtained by deduction of the initial lambda value from the aged lambda value.

### Percentage of Difunctional Components:

The percentage of difunctional components in the isocyanate component is determined by GPC with IR detection at 237 nm. It is calculated as the % area of the peak or peaks corresponding to the difunctional isocyanate component and, in case uretonimine-modified isocyanates are used, such as uretonimine-modified MDI, also including the % area of the peaks corresponding to the MDI-uretonimine (mono, bis and tris), all % areas calculated relative to the total peak area of all the peaks of the isocyanate component.

The GPC settings are as follows:
Three 30 cm columns are used in series (500A, 100A, 50A), 5μ packing material
PDA detector—237 nm
Eluent: methylene chloride
Flow: 0.9 mL/min
Concentration of sample: 0.1% (in methylene chloride)

TABLE 2
Compositions (C) of Examples 1 to 2 and 4 to 10, and Comparative Examples 3 and 11 to 13

| Component | | E1 | E2 | CE3 | E4 | E5 | E6 | E7 | E8 | E9 | E10 | CE11 | CE12 | CE13 |
|---|---|---|---|---|---|---|---|---|---|---|---|---|---|---|
| Polyol blend comprising | | 127 | 104 | 106 | 106 | 106 | 104 | 106 | 115 | 106 | 106 | 127 | 104 | 115 |
| Polyester polyol 2 as | | | | | | | | | | | | | | |
| isocyanate-reactive | | | | | | | | | | | | | | |
| component (B1) | | | | | | | | | | | | | | |
| Blowing agent (BA) = | | 44 | 31 | 33 | 32 | 31 | 31 | 28 | 29 | 29 | 29 | 44 | 32 | 36 |
| Solstice ® LBA | | | | | | | | | | | | | | |
| Isocyanate | Average | | | | | | | | | | | | | |
| component (A1) | Fₙ* | | | | | | | | | | | | | |
| Suprasec ® 2085 | 2.90 | 87 | | | | | | | | 107 | 107 | 207 | 169 | 144 |
| Suprasec ® 2020 | 2.10 | 87 | 180 | | | | | | | | | | | |
| Lupranat ® M 20 S | 2.70 | | | 160.2 | | | | | | | | | | |
| Lupranat ® M 10 R | 2.60 | | | | 160.2 | | | | | | | | | |
| Voranale ™M2940 | 2.30 | | | | | 157 | | | | | | | | |
| Suprasec ® 2029 | 2.10 | | | | | | 211 | | | | | | | |
| Ongronat ® 3050 | 2.00 | | | | | | | 151 | 130 | | | | | |
| Lupranat ® T80 | 2.00 | | | | | | | | | 35.8 | | | | |
| Lupranat ® T65 | 2.00 | | | | | | | | | | 35.8 | | | |

TABLE 3
Properties eftbe compositions (C) of Examples 1 to 2 and 4-10, and Comparative Examples 3 and 11 to 13
of Table 1 and the resulting ripid PUR and PIR foams

| Example number | E1 | E2 | CE3 | E4 | E5 | E6 | E7 | E8 | E9 | E10 | CE11 | CE12 | CE13 |
|---|---|---|---|---|---|---|---|---|---|---|---|---|---|
| Preparation method | Pilot | Pilot | Lab | Lab | Lab | Pilot | Lab | Lab | Lab | Lab | Lab | Lab | Lab |
| PUR/PIR | PIR | PIR | PIR | PIR | PIR | PIR | PIR | PUR | PIR | PIR | PIR | PIR | PUR |
| Isocyanate Index X | 270 | 270 | 270 | 270 | 270 | 270 | 270 | 110 | 270 | 270 | 335 | 270 | 110 |
| Overall average | 2.50 | 2.10 | 2.70 | 2.60 | 2.30 | 2.05 | 2.00 | 2.00 | 2.67 | 2.67 | 2.90 | 2.90 | 2.90 |
| functionality | | | | | | | | | | | | | |
| % Di-functional isocyanate | / | 84.35 | 41.75 | 49.75 | 61.68 | 70.44 | 99.51 | 99.51 | / | / | 32.65 | / | / |
| components | | | | | | | | | | | | | |
| Rigid foam properties | | | | | | | | | | | | | |
| Delta lambda (mW/m · K) | 1.11 | 0.65 | 1.31 | 1.16 | 0.88 | 0.60 | 0.35 | 0.49 | 1.17 | 1.19 | 2.89 | 1.70 | 1.44 |

Overall, the results in Table 3 show that the delta lambda of the rigid PUR or PIR foams produced according to the method of the present invention could significantly be reduced (Examples 1-2 and 4-10) compared to rigid PUR or PIR foams with the same isocyanate index but produced with the only isocyanate component having an average functionality equal to or higher than 2.70 (Comparative Examples CE 3 and 11-13).

In Example 1, the isocyanate component is a mixture of an isocyanate component (A1) having an average functionality of less than 2.70 (Suprasec® 2020) and an isocyanate component having an average of more than 2.7 (Suprasec® 2085). However, the overall average functionality is equal to 2.50 ((2.9*(87/174)+2.1*(87/174)) and thereby still less than 2.70. The delta lambda value of Example 1 is much lower than the delta lambda value of Comparative Example 12, which is produced at the same isocyanate index but is based on an isocyanate component having an average functionality of equal to or higher than 2.70.

In Examples 2 and 4 to 8 the influence of the average functionality of the isocyanate component (A1) on the delta lambda value is further shown. When an isocyanate component (A1) with a lower average functionality is used, the delta lambda becomes smaller.

| Component | | E14 | E15 | E16 | CE17 | CE18 | CE19 |
|---|---|---|---|---|---|---|---|
| Isocyanate-reactive | | | | | | | |
| component (B1) | | | | | | | |
| Polyester polyol 1 | | 100 | | | 100 | | |
| Polyester polyol 2 | | | 100 | | | 100 | |
| Polyester polyol 3 | | | | 100 | | | 100 |
| Surfactant Tegostab® | | 3 | 3 | 3 | 3 | 3 | 3 |
| B8513 | | | | | | | |
| Fire retardant | | 10 | 10 | 10 | 10 | 10 | 10 |
| TCPP | | | | | | | |
| Blowing agent (BA) = | | 30 | 30 | 30 | 30 | 30 | 30 |
| Solstice ® LBA | | | | | | | |
| isocyanate | | | | | | | |
| component | Average | | | | | | |
| (A1) | functionality | | | | | | |
| Suprasec ® | 2.10 | 200 | 200 | 200 | | | |
| 2020 | | | | | | | |
| Suprasec ® | 2.90 | | | | 194 | 194 | 194 |
| 2085 | | | | | | | |

| | | | | | | |
|---|---|---|---|---|---|---|
| PUR/PIR | PIR | PIR | PIR | PIR | PIR | PIR |
| isocyanate index X | 250 | 330 | 400 | 250 | 330 | 400 |
| Delta Lambda | 0.66 | 0.87 | 1.11 | 1.34 | 2.29 | 2.64 |
| (mW/m · K) | | | | | | |

Overall, the results in Table 4 show that the delta lambda of the rigid PUR or PIR foams produced according to the method of the present invention could significantly be reduced (Examples 14-16) compared to rigid PUR or PIR foams with the same isocyanate index but produced with the only isocyanate component having an average functionality of equal to or more than 2.70 (Comparative Examples CE 17-19).

In Examples 14-16 and Comparative Examples 17-19 the influence of the average functionality of the isocyanate component (A1) on the delta lambda value is further shown. When an isocyanate component (A1) with a lower average functionality is used, the delta lambda becomes smaller.

Further, the influence of the isocyanate index X of the composition (C) on the delta lambda value is clearly shown. When a PIR rigid foam is produced according to the method of the present invention having a higher isocyanate index X, then the resulting delta lambda value is relatively higher as well. This trend is shown in Examples 14-16 and Comparative Examples 17-19.

TABLE 5
Compositions (C) of Examples 21 to 22, and Comparative
Example 11 and 20 and the properties of the resulting ripid foams

| Component | | CE20 | E21 | E22 | CE11 |
|---|---|---|---|---|---|
| Polyol blend comprising | | 127 | 127 | 127 | 127 |
| polyester polyol 2 | | | | | |
| as isocyanate-reactive | | | | | |
| component (B1) | | | | | |
| Blowing agent (BA) = | | 44 | 47 | 46 | 44 |
| Solstice ® LBA | | | | | |
| Isocyanate | Average | | | | |
| component (A1) | Functionality | | | | |
| Suprasec ® 2085 | 2.90 | 157 | 61 | 116 | 207 |
| Suprasec ® 2020 | 2.10 | 52 | | | |
| Suprasec ® 2029 | 2.10 | | 183 | 116 | |

| Overall average | 2.70 | 2.30 | 2.50 | 2.90 |
|---|---|---|---|---|
| functionality isocyanate | | | | |
| component mixture | | | | |
| Preparation method | Lab | Lab | Lab | Lab |
| PUR/PIR | PIR | PIR | PIR | PIR |
| Isocyanate Index X | 335 | 335 | 335 | 335 |
| Rigid foam properties | | | | |
| Delta lambda (mW/m · K) | 2.65 | 1.29 | 1.57 | 2.89 |

The results in Table 5 confirm that the influence of the average functionality of the isocyanate components on the delta lambda value holds for mixtures of isocyanate components which comprise at least one isocyanate component (A1) having an average functionality less than 2.70 and of which the overall average functionality is less than 2.70. When the overall average functionality of the used mixture of isocyanate components becomes higher, the delta lambda value becomes higher as well (Examples 21-22). These results further indicate that at least one isocyanate component (A1) having an average functionality of less than 2.70 is required and in the case of mixtures, the overall average functionality needs to be below 2.70 as well.

TABLE 6
Compositions (C) of Examples 23 to 28, the properties of these
compositions (C) and the resulting rigid foams

| Component | | | E23 | E24 | E25 | E26 | E27 | E28 |
|---|---|---|---|---|---|---|---|---|
| Polyol blend comprising polyester polyol 2 as | | | 106 | 106 | 106 | 106 | 106 | 106 |
| isocyanate-reactive component (B1) | | | | | | | | |
| Blowing agent (BA) = Solstice ® LBA | | | 34 | 28 | 26 | 29 | 33 | 40 |
| isocyanate | Average | | | | | | | |
| component (Al) | Functionality | Modified? | | | | | | |
| Suprasec ® 2020 | 2.10 | Yes | 171 | | | | | |
| Ongronat ® 3050 | 2.00 | No | | 151 | | | | |
| Luprana t® MI | 2.00 | No | | | 152 | | | |
| Lupranat ® MIP | 2.00 | No | | | | 151.5 | | |
| Lupranat ® MM103 | 2.20 | Yes | | | | | 172.1 | |
| Lupranat ® MP102 | 2.05 | Yes | | | | | | 221 |

| Preparation method | Lab | Lab | Lab | Lab | Lab | Lab |
|---|---|---|---|---|---|---|
| PUR/PIR | PIR | PIR | PIR | PIR | PIR | PIR |
| Isocyanate Index X | 270 | 270 | 270 | 270 | 270 | 270 |
| Rigid foam properties | | | | | | |
| Delta lambda (mW/m · K) | 0.47 | 0.33 | 0.50 | 0.31 | 0.48 | 0.52 |

The results in Table 6 show that the influence of the type of modification of the isocyanate component (A1) is negligible as long as the average functionality of the isocyanate component (A1) is lower than 2.70 (Examples 23-28).

TABLE 7
Compositions (C) of Examples 31 to 37, and Comnarativo Examples 29
to 30 and the properties of the resulting rigid foams

| Component | | CE29 | CE30 | E31 | E32 | E33 | E34 | E35 | E36 | E37 |
|---|---|---|---|---|---|---|---|---|---|---|
| Isocyanate-reactive | | | | | | | | | | |
| component (B1) | | | | | | | | | | |
| Polyester polyol 1 | | 100 | | 100 | | 100 | | 100 | | 100 |
| Polyester polyol 3 | | | 100 | | 100 | | 100 | | 100 | |
| Surfactant | | 3 | 3 | 3 | 3 | 3 | 3 | 3 | 3 | 3 |
| Tegostab ® 88513 | | | | | | | | | | |
| Fire retardant | | 10 | 10 | 10 | 10 | 10 | 10 | 10 | 10 | 10 |
| TCPP | | | | | | | | | | |
| Blowing agent (BA) = | | 40 | 42 | 38 | 41 | 43 | 40 | 42 | 40 | 41 |
| Solstice ® LBA | | | | | | | | | | |
| Isocyanate | | | | | | | | | | |
| component | Average | | | | | | | | | |
| (A1) | functionality | | | | | | | | | |
| Suprasec ® | 2.90 | 194 | 194 | | 48 | 87 | 87 | 146 | 146 | |
| 2085 | | | | | | | | | | |
| Suprasec ® | 2.10 | | | 240 | 180 | 120 | 120 | 60 | 60 | 173 |
| 2029 | | | | | | | | | | |

| | | | | | | | | | |
|---|---|---|---|---|---|---|---|---|---|
| Overall average | 2.90 | 2.90 | 2.10 | 2.27 | 2.44 | 2.44 | 2.67 | 2.67 | 2.10 |
| functionality isocyanate | | | | | | | | | |
| component mixture | | | | | | | | | |
| PUR/PIR | PIR | PIR | PIR | PIR | PIR | PIR | PIR | PIR | PIR |
| Isocyanate index X | 250 | 400 | 250 | 400 | 250 | 400 | 250 | 400 | 180 |
| Delta Lambda | 1.97 | 2.55 | 0.69 | 1.59 | 0.98 | 1.66 | 1.39 | 2.12 | 0.43 |
| (mW/m · K) | | | | | | | | | |

The results in Table 7 further confirm that the influence of the average functionality of the isocyanate components on the delta lambda value holds for mixtures of isocyanate components which comprise at least one isocyanate component (A1) having an average functionality less than 2.70 and of which the overall average functionality is less than 2.70.

TABLE 8
Compositions (C) of Examples 38 to 40, the properties
of these compositions and the resulting rigid foams

| Component | | E38 | E39 | E40 |
|---|---|---|---|---|
| Polyol blend comprising polyester polyol 2 | | 108 | 108 | 108 |
| as isocyanate-reactive component (B1) | | | | |
| Blowing agent = | | 16.5 | 16.5 | 16.5 |
| i-pentane/n-pentane in ratio 75/25 | | | | |
| Isocyanate | Average | | | |
| component (A1) | Functionality | | | |
| Suprasec ® 2085 | 2.90 | 112.5 | | |
| Suprasec ® 2020 | 2.10 | 112.5 | 233 | |
| Suprasec ® 2029 | 2.10 | | | 273 |

| Overall average functionality isocyanate | 2.50 | 2.10 | 2.10 |
|---|---|---|---|
| component mixture | | | |
| Preparation method | Pilot | Pilot | Pilot |
| PUR/PIR | PIR | PIR | PIR |
| Isocyanate Index X | 270 | 270 | 270 |
| Rigid foam properties | | | |
| Delta lambda (mW/m · K) | 0.74 | 0.65 | 0.63 |

The results in Table 8 show that a mixture of blowing agents can be used in the composition (C) of the rigid PUR or PIR foams produced according to the method of the present invention. A mixture of blowing agents consisting of i-pentane/n-pentane in a weight ratio of 75/25 and having an initial thermal conductivity value (lambda value) of 13.50 mW/m·K (measured according to the THW method at 10° C.) is used in Examples 38-40. In Examples 38-39 the influence of the average functionality of the isocyanate component (A1) on the delta lambda value is further shown. When an isocyanate component (A1) with a lower average functionality is used, the delta lambda becomes smaller. Examples 39-40 show that the influence of the type of modification of the isocyanate component (A1) is negligible in view of the delta lambda values as long as the average functionality of the isocyanate component (A1) is lower than 2.70.

The following raw materials have been used in the Example 41 and Comparative Examples 42-43:

TABLE 9
Isocyanate component raw materials used in the Examples

| | | Viscosity | | |
|---|---|---|---|---|
| Isocyanate | % | (in mPa · s | | |
| component | NCO | at 25° C.) | Description | Company |
| Suprasec ® 2020 | 29.5 | 40 | Uretonimine- | Huntsman |
| | | | modified | Corporation |
| | | | 4,4′-MDI | |
| Suprasec ® 5005 | 30.8 | 210 | pMDI | Huntsman |
| | | | | Corporation |

### Isocyanate-Reactive Component (B1):

### Polyether Polyols:

Daltolac® R260: sucrose based polyol, hydroxyl value 310 mg KOH/g, functionality: 4-4.5, viscosity 25° C.: 1450 mPa·s (available from Huntsman)
Daltolac® R145: amine based polyol, hydroxyl value 310 mg KOH/g, functionality: 2-3, viscosity 25° C.: 2000 mPa·s (available from Huntsman)
Daltolac® R159: aromatic amine based polyol, hydroxyl value 500 mg KOH/g, functionality: 4 (available from Huntsman)
Voranol® WK 3138: polyether triol, hydroxyl value 56 mg KOH/g, functionality: 3, viscosity 25° C.: 485 mPa·s (available from DOW)

### Blowing Agents:

HFC245fa, 1,1,1,3,3-pentafluoropropane, boiling point 15.3° C., thermal conductivity 11.80 mW/m·K at 10° C.

### Catalysts:

PMDETA: N,N,N′,N″,N″-pentamethyldiethylenetramine
Polycat®-8: N,N-dimethylcyclohexylamine (available from Evonik)

### Other Ingredients:

Jeffsol® PC: propylene carbonate (available from Huntsman)
Tegostab® B 8513: surfactant (polysiloxane-polyether-copolymer) (available from Evonik)
Water: used as chemical blowing agent
   General Procedure for Preparing Rigid PUR or PIR Foams Using a Mould Lined Up with Gas-Tight Facing Sheets.

Gas-tight procedure: The isocyanate-reactive components (i.e. the polyol), the other ingredients (water, catalyst, and surfactant) and the blowing agents were mixed in a plastic cup until a homogeneous mixture was obtained. The isocyanate component was poured into the cup to obtain the reactive mixture which was immediately stirred by a stirrer at 3000 rpm for 10 seconds. The obtained mixture was transferred into a mould (5 cm thickness), lined up with a gas-tight facer (5 layer complex PE/Kraft 85-110/glue/Alu/PE20). After 10 minutes the rigid PUR or PIR foam was removed, cut to the required dimensions (30 cm*30 cm) and the initial thermal conductivity was measured. The amounts of the isocyanate-reactive component and the isocyanate component were adapted to achieve the desired isocyanate index X and are detailed in the tables below.

General Procedure for Preparing Rigid PUR or PIR Foams without Using a Mould Lined Up with Gas-Tight Facing Sheets.

Without gas-tight procedure: The isocyanate-reactive components (i.e. the polyol), the other ingredients (water, catalyst, and surfactant) and the blowing agents were mixed in a plastic cup until a homogeneous mixture was obtained. The isocyanate component was poured into the cup to obtain the reactive mixture which was immediately stirred by a stirrer at 3000 rpm for 10 seconds.

The obtained mixture was transferred onto a paper liner. After 10 minutes the rigid PUR or PIR foam was removed, cut to the required dimensions (30 cm*30 cm) and the initial thermal conductivity was measured. The amounts of the isocyanate-reactive component and the isocyanate component were adapted to achieve the desired isocyanate index X and are detailed in the tables below.

TABLE 10
Compasition (C) of Example 41, and Comparative Example
42-43, and the properties of the resultinq rigid foams

| Component | | E41 | CE42 | CE43 |
|---|---|---|---|---|
| Polyol blend | | | | |
| comprising isocyanate- | | | | |
| reactive component (B1) | | | | |
| Daitolac ® R260 | | 50 | 50 | 50 |
| Daitolac ® R145 | | 26 | 26 | 26 |
| Daitolac ® R159 | | 19 | 19 | 19 |
| Voranol ® WK3138 | | 1.5 | 1.5 | 1.5 |
| Catalysts | | | | |
| PMDETA | | 0.3 | 0.3 | 0.3 |
| Polycat ® 8 | | 1.5 | 1.5 | 1.8 |
| Other ingredients | | | | |
| Jeffsol ® PC | | 1.5 | 1.5 | 1.5 |
| water | | 1.4 | 1.4 | 1.4 |
| Tegostab ® B8513 | | 2.5 | 2.5 | 2.5 |
| Blowing agent (BA) = | | 22 | 24 | 24 |
| HFC245fa | | | | |
| Isocyanate | Average | | | |
| component (A1) | Functionality | | | |
| Suprasec ® 2020 | 2.10 | 140 | 140 | |
| Suprasec ® 5005 | 2.70 | | | 136 |

| Preparation method | Gas-tight | NO Gas-tight | NO Gas-tight |
|---|---|---|---|
| PUR/PIR | PUR | PUR | PUR |
| Isocyanate Index X | 110 | 110 | 110 |
| Rigid foam properties | | | |
| Delta lambda (mW/m · K) | 1.28 | 4.32 | 4.11 |

The results in Table 10 show that the requirement of rigid PUR and PIR foams being produced using a mould lined up with gas-tight facing sheets. In Comparative Examples 42-43 rigid PUR foams are produced without using a mould lined up with gas-tight facing sheets, resulting in high delta lambda values in comparison with Example 41 which is produced using a mould lined up with gas-tight facing sheets. This indicates that it is required that the rigid PUR and PIR foams are produced between gas-tight facing sheets to synergistically enhance the effect of using isocyanate components (A1) having an average functionality of less than 2.70 on the ageing behavior of the rigid PUR or PIR foams produced according to the method of the present invention. When no gas-tight facing sheets are used in the production of rigid PUR and PIR foams, there is no influence of the average functionality of the isocyanate components (A1) on the ageing behaviour of the rigid PUR and PIR foams.

The following raw materials have been used in the Examples 44-45 and Comparative Examples 46-47:

TABLE 11
Isocyanate component raw materials used in the Examples

| | | Viscosity | | |
|---|---|---|---|---|
| Isocyanate | % | (in mPa · s | | |
| component | NCO | at 25° C.) | Description | Company |
| Suprasec ® 2020 | 29.5 | 40 | Uretonimine- | Huntsman |
| | | | modified | Corporation |
| | | | 4,4′-MDI | |
| MDI Suprasec ® 5005 | 30.8 | 210 | Crude MDI | Huntsman |
| | | | | Corporation |
| TDI Lupranat ® T80 | 48.3 | 3 | Toluene | BASF |
| | | | diisocyanate | |

### Isocyanate-Reactive Component:

Polyester polyol 1: polyester polyol (based on phthalic anhydride), hydroxyl value 315 mgKOH/g, functionality: 2, viscosity 25° C.: 2800 mPa·s
Polyether polyol 2: sorbitol based polyether polyol, hydroxyl value 490 mg KOH/g, functionality: 4-4.5, viscosity 25° C.: 9500 mPa·s

### Blowing Agents:

Solkane® 365 mfc: HFO-1336mzz, boiling point 40° C., thermal conductivity 10.60 mW/m·K at 10° C.
Solstice® LBA: HFO-1233zd E, trans-1-chloro-3,3,3 trifluoropropene, boiling point 19° C. thermal conductivity 9.00 mW/m·K at 10° C. (commercially available from Honeywell)

### Catalysts:

Dabco® TEDA-L33: 1,4-Diazabicyclo[2.2.2]octane (available from Evonik)

### Other Ingredients:

Fire retardant TCPP: tris(chloropropyl)phosphate
Surfactant SH-193: similar as DC 193 (silicone surfactant from DOW Corning)
   General Procedure for Preparing Rigid PUR or PIR Foams Using a Mould Lined Up with Gas-Tight Facing Sheets.

Gas-tight procedure: The isocyanate-reactive components (i.e. the polyol), the other ingredients (water, catalyst, and surfactant) and the blowing agents were mixed in a plastic cup until a homogeneous mixture was obtained. The isocyanate component was poured into the cup to obtain the reactive mixture which was immediately stirred by a stirrer at 3000 rpm for 10 seconds. The obtained mixture was transferred into a mould (5 cm thickness), lined up with a gas-tight facer (5 layer complex PE/Kraft 85-110/glue/Alu/PE20). After 10 minutes the rigid PUR or PIR foam was removed, cut to the required dimensions (30 cm*30 cm) and the initial thermal conductivity was measured. The amounts of the isocyanate-reactive component and the isocyanate component were adapted to achieve the desired isocyanate index X and are detailed in the tables below.

General Procedure for Preparing Rigid PUR or PIR Foams without Using a Mould Lined Up with Gas-Tight Facing Sheets.

Without gas-tight procedure: The isocyanate-reactive components (i.e. the polyol), the other ingredients (water, catalyst, and surfactant) and the blowing agents were mixed in a plastic cup until a homogeneous mixture was obtained. The isocyanate component was poured into the cup to obtain the reactive mixture which was immediately stirred by a stirrer at 3000 rpm for 10 seconds.

The obtained mixture was transferred onto a paper liner. After 10 minutes the rigid PUR or PIR foam was removed, cut to the required dimensions (30 cm*30 cm) and the initial thermal conductivity was measured. The amounts of the isocyanate-reactive component and the isocyanate component were adapted to achieve the desired isocyanate index X and are detailed in the tables below.

TABLE 12
Compositions (C) of Examples 44-45, and Comparative
Examples 46-47, the properties of the resulting rigid foams

| Component | | E44 | E45 | CE46 | CE47 |
|---|---|---|---|---|---|
| Polyol blend | | | | | |
| comprising isocyanate- | | | | | |
| reactive component (B1) | | | | | |
| polyester polyol 1 | | 30 | 30 | 30 | 70 |
| polyether polyol 2 | | 70 | 70 | 70 | 30 |
| Catalysts | | | | | |
| Dabco ® TEDA-L33 | | 2.2 | 3.0 | 3.0 | 1.5 |
| Other ingredients | | | | | |
| Fire retardant TCPP | | 20 | 20 | 20 | 20 |
| Surfactant Tegostab ® 88513 | | 3 | 3 | 3 | 3 |
| Blowing agent (BA) = | | 34 | 39 | 39 | 32 |
| HFO-1336mzz | | | | | |
| Isocyanate | Average | | | | |
| component (A1) | Functionality | | | | |
| MDI/TDI (70/30) | 2.50 | 110 | | | 90.8 |
| Suprasec ® 2020 | 2.10 | | 132 | 132 | |

| Preparation method | Gas- | Gas- | NO | NO |
|---|---|---|---|---|
| | tight | tight | Gas-tight | Gas-tight |
| PUR/PIR | PUR | PUR | PUR | PUR |
| Isocyanate index X | 120 | 120 | 120 | 120 |
| Rigid foam properties | | | | |
| Delta lambda (mW/m · K) | 0.51 | 0.15 | 4.06 | 3.56 |

The results in Table 12 show the requirement of rigid PUR and PIR foams being produced using a mould lined up with gas-tight facing sheets. In Comparative Examples 46-47 rigid PUR foams are produced without using a mould lined up with gas-tight facing sheets, resulting in high delta lambda values in comparison with Examples 44-45 which are produced using a mould lined up with gas-tight facing sheets. This indicates that it is required that the rigid PUR and PIR foams are produced between gas-tight facing sheets to synergistically enhance the effect of using isocyanate components (A1) having an average functionality of less than 2.70 on the ageing behaviour of the rigid PUR or PIR foams produced according to the method of the present invention. When no gas-tight facing sheets are used in the production of rigid PUR and PIR foams, there is no influence of the average functionality of the isocyanate components (A1) on the ageing behaviour of the rigid PUR and PIR foams.

1-15. (canceled)

16. A method for preparing rigid polyisocyanurate (PIR) foams [rigid PIR foam, herein after] in which method the rigid PIR foam is prepared by reacting a composition (C) comprising:
at least one isocyanate-reactive component having functional groups selected from hydroxyl, amine and thiol groups [isocyanate-reactive component (B1), herein after];
at least one isocyanate component having an average functionality of less than 2.70 [isocyanate component (A1), herein after];
at least one blowing agent [blowing agent (BA), herein after]; with the proviso that the overall average functionality [F_{n,avg}(A), herein after] of all isocyanate components present in the composition (C) is less than 2.70; and
wherein the composition (C) is characterized by an isocyanate index X in the range from 200<X≤400; and wherein the rigid PIR foams are produced between gas-tight facing sheets; and
wherein the rigid PIR foam is characterized by a difference between the initial thermal conductivity value λᵢₙᵢ and the aged thermal conductivity value λ_{aged} (Δλ), of said rigid foam wherein:
λ2<[6.49−(4.46*F_{n,avg}(A))−(0.02348*X)+(0.492*F_{n,avg}(A)*F_{n,avg}(A))+(0.01343*F_{n,avg}(A)*X)+0.3],
wherein the initial thermal conductivity value λᵢₙᵢ and the aged thermal conductivity value λ_{aged}, expressed as mW/m·K at 10° C., are measured in accordance with ASTM C518 with a Fox 304 thermal conductivity instrument with a temperature gradient from 0° C. to 20° C., the initial thermal conductivity value λᵢₙᵢ is measured within 24 hours after production of the rigid PIR foam, the aged thermal conductivity value λ_{aged} is measured after ageing at 23° C./50% RH until the thermal conductivity difference between three consecutive weekly measurements is less than 0.05 mW/m·K.

17. The method according to claim 16, wherein the isocyanate index X ranges from 270 to 400.

18. The method according to claim 16, wherein the composition (C) is characterized by an isocyanate index X in the range from 270≤X≤335.

19. The method according to claim 16, wherein the at least one blowing agent (BA) has a thermal conductivity value λ of equal to or less than 13.00 mW/m·K, preferably equal to or less than 12.50 mW/m·K, more preferably less than 12.00 mW/m·K, more preferably less than 11.50 mW/m·K, even more preferably less than 11.00 mW/m·K, yet even more preferably less than 10.50 mW/m·K, most preferably less than 10.00 mW/m·K, measured at 10° C. in accordance with a transient hot wire method (THW method), with the proviso that the overall thermal conductivity value λ of all blowing agents present in the composition (C) is equal to or less than 13.00 mW/m·K, preferably equal to or less than 12.50 mW/m·K, more preferably less than 12.00 mW/m·K, more preferably less than 11.50 mW/m·K, even more preferably less than 11.00 mW/m·K, yet even more preferably less than 10.50 mW/m·K, most preferably less than 10.00 mW/m·K.

20. The method according to claim 16, wherein the blowing agent (BA) is selected from methyl formate, 1,1,1,2-tetrafluoroethane, dimethoxymethane, pentafluoroethane, 1,1,1,3,3-pentafluoropropane (HFC245fa), 1,1,1,3,3-pentafluorobutane (Solkane® 365), difluoromethane, any hydrofluoroolefins (HFO) such as 2,3,3,3-tetrafluoropropene, 3,3,3-trifluoropropene, 1,1,1,4,4,4-hexafluoro-2-butene, 2-bromopentafluoropropene, 1-bromopentafluoropropene, or any HCFO such as 1-chloro-3,3,3-trifluoropropene or 1,1-dichloro-3,3,3-trifluoropropene or 2-chloro-3,3,3-trifluoropropene, or mixtures of two or more thereof, more preferably from trans-1-chloro-3,3,3-trifluoropropene, trans-1,3,3,3-tetrafluoropropene or 1,1,1,4,4,4-hexafluoro-2-butene, cyclopentane.

21. The method according to claim 16, wherein the average functionality of the at least one isocyanate component (A1) is equal to or less than 2.60, more preferably equal to or less than 2.50, preferably equal to or less than 2.40, more preferably equal to or less than 2.30, even more preferably equal to or less than 2.20, yet even more preferably equal to or less than 2.10 and wherein the overall average functionality of all the isocyanate components in the composition (C) is equal to or less than 2.60, more preferably equal to or less than 2.50, preferably equal to or less than 2.40, more preferably equal to or less than 2.30, even more preferably equal to or less than 2.20, yet even more preferably equal to or less than 2.10.

22. The method according to claim 16, wherein the at least one isocyanate component (A1) is an aromatic isocyanate component (A1) with the proviso that when more than one isocyanate component is present in the composition (C), all isocyanate components are aromatic isocyanate components.

23. The method according to claim 16, wherein the isocyanate-reactive component (B1) is having functional groups comprising hydroxyl such as polyether polyols, polyester polyols and mixtures thereof.

24. The method according to claim 16, wherein the composition (C) comprises other common additional ingredients selected from any combination of the following: heat and ultraviolet light stabilizers, catalysts, pH stabilizers, antioxidants, dulling agents, nucleating agents, surfactants, carbon-derived additives (such as carbon black, graphite), thixotropic agents and fillers such as clay particles, processing aids, viscosity reducers, such as 1-methyl-2-pyrrolidinone, propylene carbonate, non-reactive and reactive flame retardants, dispersing agents, plasticizers, mould release agents, compatibility agents, and additives from natural resources such as lignin.

25. The method according to claim 16, wherein the gas-tight facing sheets are selected from facing sheets of aluminum foil, lacquered aluminum foil, aluminum foil bonded with plastic film, aluminum foil bonded with paper, or a multilayer with aluminum film or metal multilayers comprising aluminum foil and those selected from gas barrier polymeric resin layers such as Ethylene Vinyl Alcohol (EVOH) copolymer resin layers or multilayers comprising said resin layers and combinations thereof.

26. A rigid PIR foam obtainable by the method according to claim 16.

27. In a laminated insulation panel for commercial built-up roofing applications; as laminated insulation panels for siding applications; as fabricated insulation panels and configurations for roofing, piping, and various other insulation applications; as core material for sandwich panels and as a component of simulated wood products for interior decor and furniture, which panel has rigid PIR foam as a component thereof, the improvement wherein said rigid PIR foam is in accordance with claim 26.
